(19) United States
(12) Patent Application Publication
(10) Pub. No.: US 2002/0138373 A1
(43) Pub. Date: Sep. 26, 2002

(54) Inventory and parts management system and method particularly suited to automotive dealer applications

(76) Inventor: Stephen D. Reading, Ann Arbor, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/101,917

(22) Filed: Mar. 19, 2002

Related U.S. Application Data
(60) Provisional application No. 60/278,054, filed on Mar. 22, 2001.

(51) Int. Cl. G06F 17/60

(52) U.S. Cl. 705/28

(57) ABSTRACT

Broadly, this invention provides “qualifying” dealers an opportunity to identify and sell parts. Although the system is described with respect to automotive dealers and manufacturers, it will be appreciated that the system and method are applicable to other types of vehicles and goods. With respect to a parts management method particularly suited to automotive dealers, the inventive approach comprises the steps of qualifying a selling dealer, querying the selling dealer on a periodic basis to identify parts which the dealer wishes to return under one or more return policies and finding a buyer for one or more of the parts. Various return policies may be accommodated, including those falling under inventory protection plans, 30-day or other time-based return program, “idle capital” policies, parts suggested for order by a stock or order process, and so forth. As an option, the method may include the step of providing a “pick list” for the selling dealer, or a “shipper advisory” for the buying dealer. According to a specific implementation using the nomenclature of the Ford Motor Company, the invention affords dealers the opportunity to sell parts they identify as (1) PIPP (i.e., under the Parts Inventory Protection Plan), (2) 30-Day Returns, and (3) “Idle Capital” to other dealers, where the same parts are faster-moving for the buying dealer.

### REFERENCE TO RELATED APPLICATION

This application claims priority from U.S. provisional patent application Ser. No. 60/278,054, filed Mar. 22, 2001, the entire content of which is incorporated herein by reference.

### FIELD OF THE INVENTION

This invention relates generally to inventory management and, in particular, to a parts inventory management system that facilitates widespread control and supports various types of automated control and routing transactions.

### BACKGROUND OF THE INVENTION

Each year, millions of dollars are wasted because automotive dealers must dispose of excess inventory. In particular, dealers that cannot sell certain parts after 6 months attempt to offer them well below cost, but still cannot unload them. Although automotive manufacturers occasionally offer to buy back some of these parts, the percentage that they accept is very low and the returned parts are often destroyed at a loss. At the same time, there may be dealers which could use at least some of the parts which other dealers cannot. Although there does exist some parts locator systems, they are very limited in capability and require significant human interaction. Thus, the need remains for a parts management system that facilitates widespread control and, ideally, supports various types of transactions on a fully automated, hands-off basis.

### SUMMARY OF THE INVENTION

Broadly, this invention provides “qualifying” dealers an opportunity to identify and sell parts. Although the system is described with respect to automotive dealers and manufacturers, it will be appreciated that the system and method are applicable to other types of vehicles and goods.

With respect to a parts management method particularly suited to automotive dealers, the inventive approach comprises the steps of qualifying a selling dealer, querying the selling dealer on a periodic basis to identify parts which the dealer wishes to return under one or more return policies and finding a buyer for one or more of the parts.

Various return policies may be accommodated, including those falling under inventory protection plans, 30-day or other time-based return program, “idle capital” policies, parts suggested for order by a stock or order process, and so forth. As an option, the method may include the step of providing a “pick list” for the selling dealer, or a “shipper advisory” for the buying dealer.

According to a specific implementation using the nomenclature of the Ford Motor Company, the invention affords dealers the opportunity to sell parts they identify as (1) PIPP (i.e., under the Parts Inventory Protection Plan), (2) 30-Day Returns, and (3) “Idle Capital” to other dealers, where the same parts are faster-moving for the buying dealer.

### BRIEF DESCRIPTION OF THE DRAWINGS

FIG. 1 is a diagram which shows how the invention is beneficial to inventory and parts transactions.

### DETAILED DESCRIPTION OF THE INVENTION

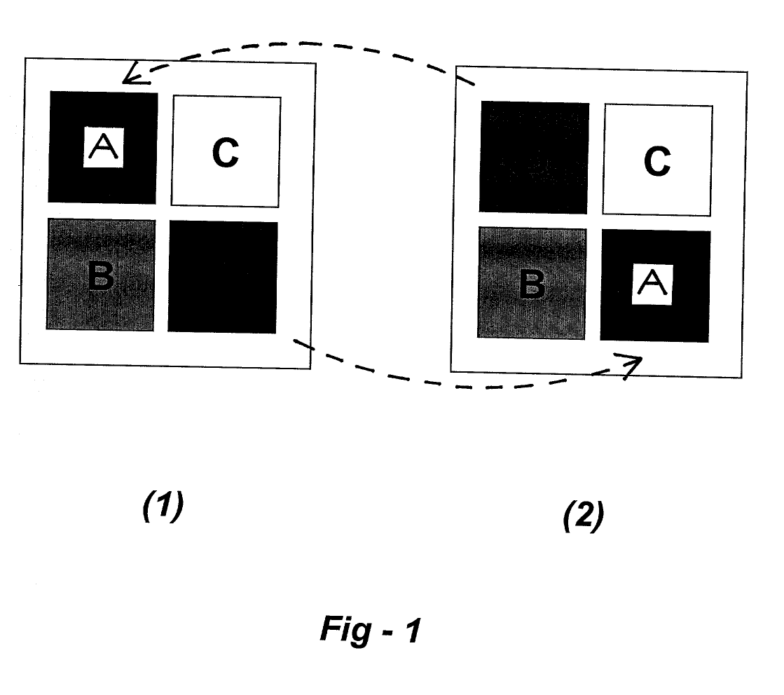

The inventive system, referred to herein as the Network Parts Alliance (NPA) is a web-based computer program interfaced with dealers' DMS (inventory computer) systems. FIG. 1 is a diagram which shows how the invention is beneficial to inventory and parts transactions, with particular significance to automotive dealers. Each dealer (1, 2, for example) typically has an inventory of many types of parts, which may be categorized by sales movement. For example, those classified in category “A” may be highly profitable. Those in category “B” may be relatively fast-moving, but not as profitable as those in the “A” category. C-category parts are generally slower moving than B, and therefore only marginally profitable, whereas the slowest moving parts, classified as C, represent a loss in the sense that they are nearly impossible to unload. However, each situation is generally aligned with a particular dealer, such that with respect to a different dealer, A parts may be B parts, C parts may be B parts, and so forth. In fact, there may be situations wherein the slowest moving parts for one dealer may represent fast-moving parts for another dealer. Accordingly, this invention seeks to find such relationships (shown with broken lines), and exploit the commercial potential.

According to the method of the invention, each “qualifying” dealer will identify parts eligible for return. Using nomenclature popularized by the Ford Motor Company, these qualified dealers may identify parts associated with (1) PIPP (i.e., under the Parts Inventory Protection Plan), (2) 30-Day Returns, and other parts which may be identified as (3) “Idle Capital.” Idle Capital will be identified according to (1) its' status (Stock Status, Non-Stock Status) and, (2) Sales History. In addition, each “qualifying” dealer will identify their Parts Suggested For Order by the Stock Order Process. It will further be appreciated that although Ford Motor designations are used, it will be apparent to those of skill that the system and method are extensible to other inventory control mechanisms through appropriate changes in definitional distinctions.

As part of normal data extraction, each night the NPA system will automatically query each NPA dealer computer to identify (1) PIPP Parts, (2) 30-Day Return Parts (3) Idle Capital Parts, and (4) Parts Suggested For Order by the Stock Order Process. NPA will “scrub” Stock Order requirements against all other NPA inventories where the same parts are identified as (1) PIPP Parts, (2) 30-Day Return Parts (3) Idle Capital Parts. PIPP and 30-Day Return parts will be matched first, followed by the Idle Capital Parts. Where there is a “match,” a shipping/distance protocol will be introduced to provide shipping from the nearest location.

NPA will transmit a “Pick List” for the Selling Dealer and a “Shipper Advisory” for the Buying Dealer. The balance of each Stock Order will then be released to FC SD.

### How Dealers Qualify For Participation (As “Buyers” Or “Sellers” or “Both”)

A successful implementation of the invention depends upon the (1) smooth, (2) reliable and (3) automatic operation of the “matching” process. NPA must be easy to use for both the Buying Dealer and the Selling Dealer.

### Parts Upgrade (PUG) Dealers

According to the invention, PUG graduate dealers, currently reporting (1) Database Accuracy 95% (or better), and (2) reporting few if any parts Without Bin Locations qualify to be both and NPA Buyer and NPA Seller. PUG graduate dealers reporting (1) Database Accuracy 95% (or better), but who also report (2) significant numbers of Parts Without Bin Locations qualify to be a BUYER Only. PUG graduate dealers reporting (1) Database Accuracy Less Than 95%, but who report (2) few if any parts Without Bin Locations qualify to be a SELLER Only.

### Non-PUG Dealers

Non-PUG dealers must Implement, Authenticate (establish audit trails), and Report (via a Web-Based Monthly Dealer Reporting System referred to herein as “DRS”) (1) Database Accuracy 95% (or better), and (2) few if any parts Without Bin Locations qualify to be both and NPA Buyer and NPA Seller. Non-PUG dealers who Implement, Authenticate (establish audit trails), and Report (via ADMI Web-Based Monthly Dealer Reporting System/“DRS”) (1) Database Accuracy 95% (or better), but who also report (2) significant numbers of Parts Without Bin Locations qualify to be a BUYER Only. Non-PUG dealers who Implement, Authenticate (establish audit trails), and Report (via ADMI Web-Based Dealer Reporting System/“DRS”) (1) Database Accuracy less than 95 percent but who report (2) few if any parts Without Bin Locations qualify to be a SELLER Only.

### Additional Functions

Physical Inventory (Idle Capital Parts Only): Non-PUG dealers will perform a Physical Inventory of all Stock Status and Non-Stock Status (1) PIPP Parts, (2) 30-Day Return Parts (3) Idle Capital Parts at the time of enrollment and every 6 months thereafter to maintain NPA Qualification status.

Enrollment: Non-PUG dealers may “apply” to enroll in NPA by agreeing to the “Terms & Conditions”

In-Dealership Operations Review: Following receipt of that Agreement, a 1.5-day in-dealership's review of key business practices will be scheduled. This review, provided at no cost to the dealership, will establish the performance reports required and determine if satisfactory performance is being achieved. If satisfactory performance is achieved, a Certificate of Achievement will be awarded and the NPA process will be activated on a timely basis. If satisfactory performance is not achieved, the dealer may elect various means to achieve minimum NPA standards, to include “for-fee” in-dealership assistance. In all cases, either a Buyer, Seller or Both, NPA dealers must abide by the NPA Terms & Conditions.

### NPA Terms & Conditions

PIPP & 30-Day Returns: Each NPA dealer who shall participate as a Seller will identify all parts eligible by program terms for return via either (1) PIPP or (2) 30-Day Returns (in the case of Ford Motor). The dealer will code parts eligible for return under PIPP with a “P”. Parts eligible for 30-Day Returns will be coded “3”. NPA sales of parts coded either “P” or “3” will reduce PIPP and “30 Day” Return credits—just as if they had been returned to Ford.

Timely Coding—PIPP: Each month, parts eligible for return via PIPP shall be identified in quantities and dollar value up to the maximum net credits available. Dealers will generate and forward to NPA a summary report reflecting the total value of parts coded “P” (Eligible For PIPP). NPA will compare dealer-coded values with Ford PIPP values. Dealers who fail to code PIPP eligible parts up to the maximum net PIPP credits available will be notified by NPA by the 15^{th} working day to complete the coding by the end of the month or lose the balance of PIPP credits not coded properly.

Retention Of PIPP Coded Parts: Unsold parts coded “P” (PIPP) must be retained (and Coded “P”) until the end of the PIPP-Return year to provide maximum exposure to the NPA PIPP/Idle Capital reduction opportunity.

Timely Coding—30 Day Returns: Dealers wishing to exercise the 30-Day Return privilege must code all such parts “3” within 10 working days of receipt. The purpose of the timely coding requirement is to make available for sale to NPA such parts identified as PIPP or 30-Day sooner rather than later. While Ford will continue to accept for return (under PIPP/30-Day) parts that remain unsold after being exposed to the NPA opportunity, dealers are required to provide maximum exposure of such parts to NPA to minimize exposure to Ford.

Retention Of 30-Day Return Parts: Program eligible parts which remain unsold through NPA after 60 days may be returned to Ford under current Program terms after 60 days of receipt but before 90 days after receipt. For a dealer, the only difference between Ford “Return” and a PIPP/30-Day “Return” is the “Destination”. Ford Returns go back to Ford, NPA Returns/Sales go to other dealers.

### Idle Capital

Each NPA Dealer who shall participate as a Seller will identify Idle Capital within the NPA Idle Capital Parameters. Idle Capital parameters are established separately for Stock Status and for Non-Stock Status parts. Dealers must identify their Idle Capital in terms of the NPA Stock Status and Non-Stock Status parameters. However, dealers may deselect and revise their parameter selections at any time, provided that they honor any sales “in process” resulting from the former parameter selections.

Stock Status Idle Capital Parameters: (1) Parts Not Sold 6 Months Or More, (2) Parts Not Sold 9 Months Or More, (3) Parts Not Sold 12 Months Or More AND—

Non-Stock Status Idle Capital Parameters: (1) Parts Not Sold 2 Months Or More, (2) Parts Not Sold 6 Months Or More, (3) Parts Not Sold 9 Months Or More, (4) Parts Not Sold 12 Months or more.

### Discounting

NPA “Pricing” is intended to be attractive to both Buyers and Sellers

Selling Dealer—PIPP & 30 Day Returns: Selling Dealer shall SELL all parts identified as “PIPP/30-Day Returns” At Current Dealer Published Prices LESS 5%—terms identical to current program.

Selling Dealer—Idle Capital: Selling Dealer shall SELL all parts identified as Idle Capital At Current Dealer Published Prices LESS 35%—Such pricing will promote the sale of parts where cost recovery is not available by other means.

Buying Dealer—PIPP & 30 Day Returns: Buying Dealer Shall Purchase All Selling Dealer Parts At Dealer Cost Less 5%.

Buying Dealer—Idle Capital: Buying Dealer Shall Purchase All Selling Dealer Parts At Dealer Cost Less 15%.

NPA: NPA shall administer NPA Terms & Conditions and NPA “Qualification/Performance Reporting, and pass all transactions to Ford Customer Service Division (FCSD) for Invoicing and Collection processes.

FCSD: (1) Ford Customer Service Division shall Invoice Buying Dealer for all Idle Capital Transactions at Dealer Cost Less 15%. (2) FCSD shall credit Selling Dealer for all NPA transactions at Dealer Cost LESS 35%. (3) FCSD shall retain 5% for Credit and Collections processing+5% Stock Order Discount. (4) FCSD shall pay NPA 10% for administering Terms & Conditions.

Freight: Selling Dealer shall ship all parts Freight Pre-Paid.

Delivery: NPA parts will be shipped or delivered on an expedited basis. The objective is SAME Day Delivery or NEXT Day arrival if Shipped. Selling dealers not achieving this performance will be awarded a shipping demerit (see “Whiffs” below)

NPA Dealer Performance: All NPA dealers (Buyers, Sellers, Both) shall participate (at no cost) in the monthly web-based ADMI Dealer Reporting System (DRS).

Performance Measures: (1) Database Accuracy—95%—According to processes and measures compatible with NPA standards of measures and methods of achievement. (2) Parts Without Bin Locations (Stock Status & Non-Stock Status)—Less Than 1% Of Total SKUs (3) Whiffs—Failure to ship (can't find, don't have, etc.) on a timely basis (see “Delivery” Performance above) Idle Capital parts or shipment of parts not meeting PIPP standards of salability and packaging/maximum of 5 per month. (4) Whaffs—Failure to accept/receive NPA parts according to NPA Terms & Conditions (return to selling dealer freight pre-paid)—maximum of 3 per month.

Performance Reporting: Dealers shall enter NPA Performance Measures in the ADMI Dealer Reporting system by 5^{th} working day each month.

Failure To Report: NPA will transmit (to Dealer & FCSD) “Failure To Report” Notification on the 6^{th} working day each month. Dealers failing to report by 10^{th} working day will be automatically notified that NPA privileges will be suspended on 15^{th} working day until satisfactory reporting is restored. Removal from “NPA Suspension” will be transmitted to both Dealers and FCSD at such time that satisfactory reporting is restored.

Failure To Perform: Since the success and acceptance of NPA depends upon the (1) smooth, (2) reliable and (3) automatic operation of the “matching” process dealers who fail to provide satisfactory performance, or who otherwise impair the success of NPA for other dealers, shall be suspended from NPA participation until NPA performance standards are achieved and accurately reported. Dealers will be automatically notified that NPA privileges will be suspended if satisfactory performance is not achieved and accurately reported by the next monthly reporting cycle. Such notification will be transmitted to FCSD and Dealers by the 10^{th} working day each month.

I claim:

1. A parts management method particularly suited to automotive dealers, comprising the steps of:
qualifying a selling dealer;
querying the selling dealer on a periodic basis to identify parts which the dealer wishes to return under one or more return policies; and
finding a buying dealer for one or more of the parts.

2. The method of claim 1, wherein the return policies includes a Parts Inventory Protection Plan.

3. The method of claim 1, wherein the return policies includes a 30-day or other time-based return program.

4. The method of claim 1, wherein the return policies includes an “Idle Capital” policy.

5. The method of claim 1, wherein the return policies includes Parts Suggested For Order by the Stock Order Process.

6. The method of claim 1, further including the step of providing a “pick list” for the selling dealer.

7. The method of claim 1, further including the step of providing a “shipper advisory” for the buying dealer.
